(19) United States
(12) Patent Application Publication
(10) Pub. No.: US 2003/0158804 A1
(43) Pub. Date: Aug. 21, 2003

(54) Method of prebidding in a combined auction format

(76) Inventors: Bob Francis, Moose Jaw (CA); Zeljko Stefanovic, Moose Jaw (CA)

Correspondence Address: MIDDLETON & REUTLINGER, 2500 BROWN & WILLIAMSON TOWER, LOUISVILLE, KY, 40202

(21) Appl. No.: 09/757,722

(22) Filed: Jan. 8, 2001

(30) Foreign Application Priority Data
Dec. 21, 2000 (CA) 2,329,282

(51) Int. Cl. G06F 17/60

(52) U.S. Cl. 705/37

(57) ABSTRACT

A system and method for the online placement of prebids in respect of an auction lot in advance of a live auction. Upon commencement of the live physical or online auction of an auction lot, the winning prebid which was accepted according to the system and method of the present invention will be submitted to the live auction. A Web site system is used to accept the details of prebids, and various methods or formulae for calculating the winning prebid are disclosed.

[symbol] which would be a silent auction which might take place over a number of weeks, or a static online auction such as those conducted on eBay™ or the like, where over the course of a period of a number of days, bidders can at their leisure submit bids. The intensity of the bidding session in a live auction results in higher prices and more excitement for bidders as well.

One of the drawbacks to a live auction, from a bidder's perspective, is that the bidder must be in physical attendance during the actual conduct of the live auction to place their bids. For any number of reasons, including the physical location of the live auction, the timing of the live auction or in any number of other circumstances, it might just be impractical for a bidder to attend the live auction, but they may wish to still submit a bid during the live auction bidding session on a particular auction lot.

### SUMMARY OF THE INVENTION

It is the object of the present invention to provide a system and method whereby a bidder could place a bid in respect of an auction lot in advance of the opening of the live auction bidding session. Within this document, this will be referred to as a “prebid”. Where more than one prebid was submitted with respect to an auction lot, a winning prebid would be selected and that prebid only would be submitted to the live auction of the auction lot.

The method and apparatus of the present invention use a prebid Web site system whereby a bidder can submit a prebid to the prebid Web site system from their bidder computer. The prebid Web site system contains a merchandise database which contains information pertaining to auction lots on which prebids can be placed, and it also contains a prebid database which contains the details of prebids which are received from bidders in respect of auction lots.

There would be a specified time frame in respect of each auction lot stored in the merchandise database within which bidders could submit prebids to the prebid Web site system. Prebids submitted either in advance of opening of said specified time frame or after the expiry of said specified time frame would be ignored. This gives the system a degree of definiteness and, while it does allow bidders to potentially place a prebid without having to attend to the actual live auction session of the auction lot in which they are interested, it is also possible by setting the specified time frames properly in respect of the various auction lots stored in the merchandise database to allow either the auctioneer or the system itself to have time to properly process and select the winning prebid from those received and prepare it for submission to the live auction.

There is disclosed in one embodiment of the present invention a method of accepting prebids in advance of a live auction, wherein the method comprises providing a prebid Web site system to accept prebids, said Web site system including a merchandise database of information pertaining to auction lots each to be sold in a live auction and a prebid database in which the details of prebids received from bidders in respect of said auction lots can be stored. Using the Web site system, prebids can be accepted in respect of an auction lot from the merchandise database within a specified time frame by allowing bidders to transmit prebids to the Web site system from their bidder computers. Each prebid transmitted, in addition to bidder identifying information and information identifying the auction lot in respect of which the prebid is placed, would include a maximum prebid amount, which would be the amount that the bidder was prepared to bid during the live auction of the auction lot.

The details of previously placed prebids and data from the merchandise database could be displayed to potential bidders in advance of their placement of a prebid in accordance with the present invention.

The prebids which are received by the Web site system would be recorded in the prebid database upon receipt thereof. Upon expiry of the specified time frame in respect of an auction lot, no further prebids would be accepted by the Web site system and the Web site system would proceed to select the winning prebid in respect of an auction lot and the winning prebid in respect of an auction lot would be submitted to the live auction of that lot.

The winning prebid selected might be the prebid with the highest maximum prebid amount, or it could be that an additional formula would be used to calculate a winning prebid. It will be understood that any type of a selection from the prebids received and stored in the prebid database within the specified time frame is contemplated within the scope of the present invention.

The prebids accepted by the Web site system of the present invention could be accepted for submission to either a physical auction, where the winning prebid would be reported to the auctioneer for manual entry into the actual live auction bidding session, or alternatively the system and method of the present invention might accept prebids for later entry into an online auction.

A live online auction is similar to a physical auction insofar as while being conducted in an online format there is still an intensive and abbreviated bidding session, likely moderated or participated in by an auctioneer. In the case of the live auction of an auction lot being an online auction, the Web site system of the present invention might be operatively connected to the auction system of the online auction and the winning prebid in respect of an auction lot might then be automatically communicated or transmitted into the bidding session of the live auction on the particular auction lot from the prebid Web site system to the auction system of the online auction. It will be understood that, the actual aggregation of prebids and calculation of the winning prebid therefrom being at the heart of this invention, the actual entry of a winning prebid into a live auction bidding session can be contemplated by one skilled in the art and that all such variations are contemplated within the scope of the present invention.

Variations on the actual prebid methodology can also be contemplated within the scope of the present invention. For example, each bidder might only be allowed to submit one prebid in respect of an auction lot, or alternatively bidders might be able to submit more than one prebid in respect of an auction lot which could in effect result in a static auction in advance of the live auction of the auction lot, since upon reviewing other prebids placed by other users with respect to the auction lot, if the bidder were able to submit more than one prebid, they could submit additional prebids if they wished to ensure that they had the winning prebid going into the live auction bidding session.

Also beyond the direct consideration of the present invention is the point within the live auction of an auction lot at which the winning prebid is submitted. It will be understood that the winning prebid might either be submitted as the opening bid or at the opening of bidding in the live auction of the auction lot, or alternatively the winning prebid might be submitted to the live auction of the auction lot at some point following the opening of bidding or in the normal course of bidding, depending on the maximum prebid amount of the winning prebid. It will be understood again that variations hereon are all contemplated within the scope of the present invention.

The Web site system of the present invention could contain, in the merchandise database, details of numerous auction lots from one or more separate live auction sales. In the case of a prebid Web site system containing auction lots in the merchandise database for more than one live auction sale, a single Web site system could be used as an aggregator or collector of prebid information with respect to all of those auction lots and then the winning prebids in respect of various auction lots could be reported out to their respective live auction sales at the appropriate times. As well, in a Web site system of the present invention containing information pertaining to auction lots in more than one live auction sale, the specified time frame in which prebids will be accepted with respect to individual auction lots might vary and, as such, prebidding on certain auction lots might automatically be ceased at a certain point while prebidding continued on other lots for which the specified time frame had yet to expire.

While it is the maximum prebid amount of the winning prebid which will be submitted as the bid amount to the live auction of the auction lot, it will be understood that there are variations which can be contemplated with respect to the selection of the winning prebid. One such variation contemplates the inclusion of a preset bid increment in respect of an auction lot stored in the merchandise database, and the optional inclusion of a minimum prebid amount in prebids submitted by bidders to the Web site system. A prebid which contained such a minimum prebid amount would be a flexible prebid and the adjustable prebid balance for that prebid would start at the minimum prebid amount of the prebid. Any prebid which did not include a minimum prebid amount would be a fixed prebid and the prebid balance of that fixed prebid would equate to the maximum prebid amount set by the bidder in submission of the prebid. The system and method of the present invention might accommodate both flexible and fixed prebids with respect to an auction lot, or might require that all prebids in respect of a particular auction lot be either fixed or flexible in nature. It will be understood that all such variations are contemplated within the scope of the present invention.

That terminology now having been established, the selection of the winning prebid in respect of an auction lot might comprise the conduct of at least one knockout calculation within which the prebid threshold would be determined, which would be the highest prebid balance of any remaining prebids in respect of the auction lot. Once the prebid threshold has been calculated, any prebids whose maximum prebid amount was less than the prebid threshold would be removed from further consideration. Also then removed from further consideration would be any flexible prebids whose the prebid balance was less than the bid threshold and the difference between the prebid balance and the maximum prebid amount of that prebid was less than the preset bid increment for the auction lot in question. Upon the removal from consideration of any flexible or fixed prebids meeting these above criteria, the prebid balance of any remaining flexible prebids would be adjusted by adding the preset bid increment of the auction lot in question thereto. Further knockout calculations would be conducted until only one prebid remained, in which case the remaining prebid would be the winning prebid in respect of the auction lot.

In respect of this incremental prebid comparison resulting in the selection of the winning prebid, the maximum bid amount of the winning prebid might be adjusted to be the final prebid balance thereof following the last knockout calculation. In the case of a flexible prebid, this would mean that the amount might be adjusted to the final incremented prebid balance, or alternatively the maximum bid amount for a winning prebid regardless of whether it was flexible or fixed might remain at its preset maximum amount as set by the bidder when the bid was submitted. It will be understood that all such variations on the calculation of a winning prebid and its maximum bid amount are contemplated within the scope of the present invention. It is specifically contemplated that in most cases it would be the desire of the operator of the prebid Web site system as well as the live auction of a particular auction lot that the maximum prebid amount of a winning prebid be the amount which is submitted to the live auction or to which the bidder placing such a prebid is committed to spend in the live auction. In the case of a flexible prebid, an amount less than the maximum prebid amount might be submitted to the live auction, but the flexible prebid could then be incremented within the live auction up to as high as the maximum prebid amount to keep that bidder in the auction.

The prebid Web site system disclosed herein would include a merchandise database containing information pertaining to auction lots to be sold in a live auction as well as a prebid database which would contain details of each prebid placed in respect of an auction lot by a bidder, including a maximum prebid amount for each prebid placed. There would also be a prebid control system which would allow placement of a prebid in respect of an auction lot within a specified time frame by receiving the details of a prebid, including the maximum prebid amount transmitted from a bidder computer as well as bidder and auction lot identification, and recording said prebid in the prebid database. Upon expiry of the specified time frame, the prebid control system would select the winning prebid from the prebids already stored in the prebid database. The winning prebid would then be submitted to the live auction of the auction lot.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a general concept diagram of the system and hardware of one embodiment of the present invention;

FIG. 2 is an architectural drawing of a prebid Web site system in accordance with FIG. 1;

FIG. 3 demonstrates the flow of a typical series of prebid transactions through the prebid Web site system of the present invention;

FIG. 4 demonstrates the flow of a prebid transaction between a bidder computer and the web site system of the present invention; and

FIGS. 5 to 7 are sample web pages which might be used in the practice of an embodiment of the present invention.

### LISTING OF DIAGRAM REFERENCE NUMERALS

1. bidder computer

2. prebid Web site system

3. server

4. Internet

5. Web browser

6. merchandise database

7. prebid database

8. HTML documents

9. computer program

10. merchandise database maintenance component

11. prebid database maintenance component

12. prebid control system

### DETAILED DESCRIPTION OF THE ILLUSTRATED EMBODIMENTS

To facilitate a complete understanding of the invention, the description of the preferred embodiments herein are arranged within the following sections:

1. Glossary of Terms and Acronyms

2. Overview of System Components and Operation

3. Merchandise Database

4. Prebid Database

5. Prebid Control System

6. Selection of the Winning Prebid

7. Conclusion

Glossary of Terms and Acronyms

The following terms and acronyms are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

Internet. A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

World Wide Web (“Web”). Used herein to refer generally to both a distributed collection of interlinked, user-viewable hypertext documents (commonly referred to as Web documents or Web pages) that are accessible via the Internet, and the client and server software components which provide user access to such documents using standardized Internet protocols.

Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

Web site. A computer system that serves informational content over a network using the standard protocols of the World Wide Web. Typically, a Web site corresponds to a particular Internet domain name, such as abc.com,” and includes the content associated with a particular organization. As used herein, the term is generally intended to encompass both the hardware/software server components that serve the informational content over the network, and the “back end” hardware/software components, including any non-standard or specialized components, that interact with the server components to perform services for Web site users.

HTTP (HyperText Transport Protocol). The standard World Wide Web client-server protocol used for the exchange of information (such as HTML documents, and client requests for such documents) between a browser and a Web server. HTTP includes a number of different types of messages which can be sent from the client to the server to request different types of server actions. There are also secure types of protocols or additions to the basic HTTP protocol used on the Internet. One of these, which is used to add security to transmissions, is a secure socket layer protocol, also referred to as “SSL”.

HTML (Hypertext Mark-up Language). A standard coding convention and set of codes for attaching presentation and linking attributes to informational content within documents. During a document authoring stage, the HTML codes are embedded within the informational content of the document and when the Web document (HTML document) is subsequently transferred from a Web server to a browser, the codes are interpreted by the browser and used to parse and display the document. In addition to specifying how the Web browser is to display a document, HTML tags can also be used to create links to other Web documents.

Overview of System Components and Operation

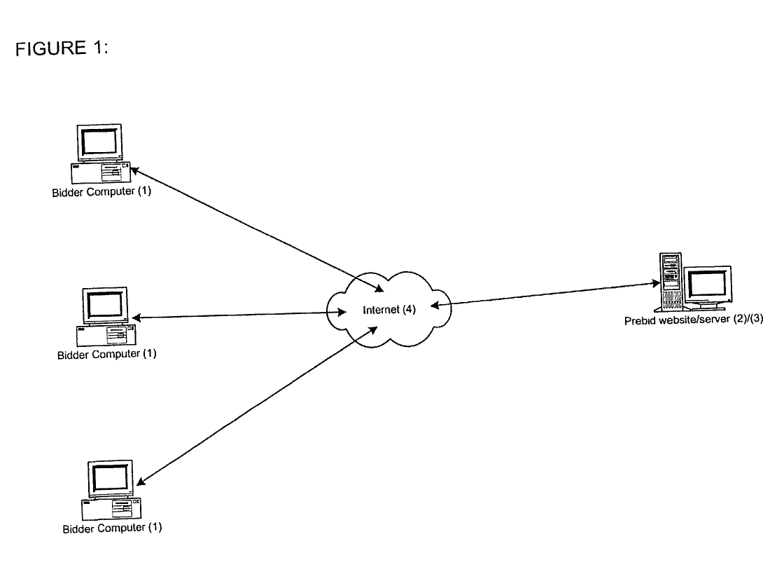

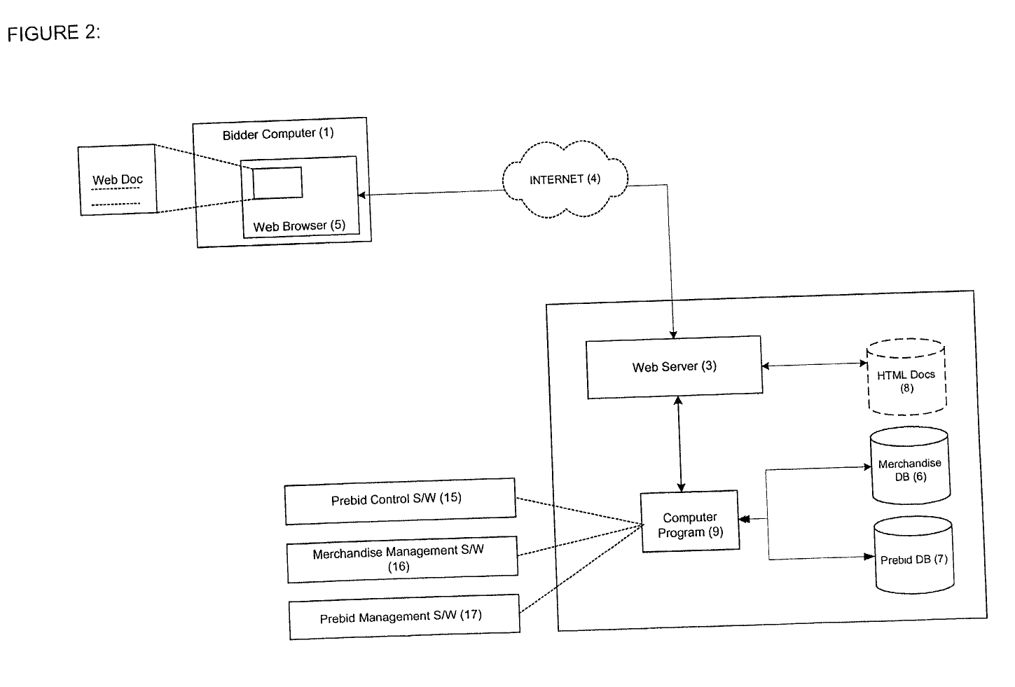

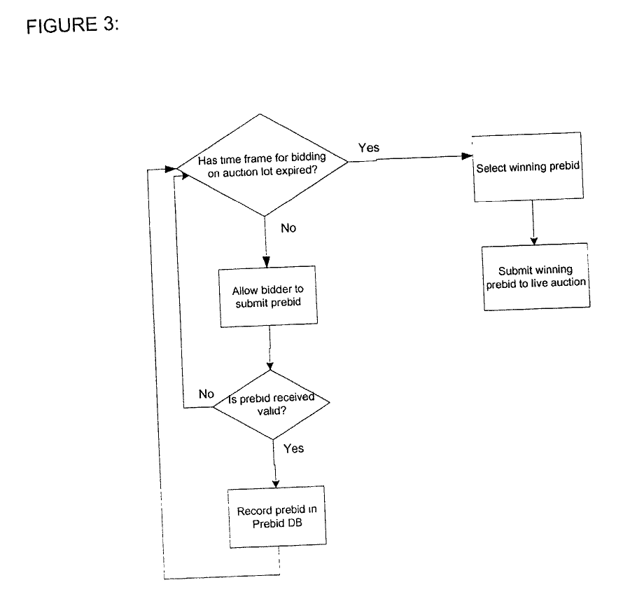

FIG. 1 illustrates the general architecture of a prebid Web site system operating in accordance with the present invention. It includes at least one bidder computer (1) and a prebid Web site system (2), which are linked together by the Internet (4). In FIG. 1 there are three bidder computers (1) shown, but it will be understood that the number of bidder computers (1) which could be engaged in a prebid process conducted by the present invention are limited only by the communications and hardware capacity of the prebid Web site system (2) and that all such numbers of bidder computers (1) are contemplated within the scope of the present invention.

The prebid Web site system (2) is a site that provides various functionality for allowing bidders to place prebids in respect of products, services or other auction lots to be given up eventually for sale by a live auction. Typically, this Web site system (2) will be operated by a business entity (referred to herein as the “auctioneer”) that handles the operation of auction sales.

The bidder computer (1) might be any type of a computing device that would allow a user/bidder to interactively browse Web sites via a Web browser (5). For example, the bidder computer (1) might be a personal computer running any one of the Microsoft Windows™ operating systems. It will be understood that other types of computing devices running other operating systems could also be used as the bidder computer (1) so long as they were able to connect to the Internet (4) and accommodate the interaction between the bidder computer (1) and the prebid Web site system (2) by a Web browser (5) installed therein, and that all such other devices are also contemplated within the scope of the present invention.

It will be understood that any type of product or service could be the auction lot which a prebid could be placed upon, and placing prebids on any type of an auction lot, service or commodity is contemplated within the scope of the present invention.

The prebid Web site system (2) of the present invention consists, hardware wise, primarily of a server (3) with the necessary software components installed therein to conduct the prebidding process as well as to communicate with the bidder computers (1). Further attributes and requirements of the server (3) and the software components installed therein will become apparent from the description to follow. The prebid Web site system (2) will interface with a bidder computer (1) by way of a bidder Web browser (5).

Software components installed on the server (3) would include a prebid control system (15), which could accept and process prebids transmitted from a bidder computer (1) to the server (3).

The prebid Web site system (2) would also include a merchandise database (6) in which would be stored the particulars of auction lots upon which it was desired to allow bidders to place prebids. The merchandise database (6), as will be outlined in further detail below, could include various descriptive information regarding an auction lot which is was desired to allow bidders to browse or view through their Web browser (5) in advance of placing a prebid.

The merchandise database (6) might also include the criteria or parameters which determine the types of prebids which are allowed to be placed by a bidder with respect to particular auction lots. The format of the prebidding process might vary between auction lots and, as such, where it was desired to vary the process or acceptable terms of prebids between auction lots those parameters could be stored in the merchandise database (6).

The prebid Web site system (2) would also include a prebid database (7), in which would be stored the particulars of prebids placed by various bidders with respect to auction lots from the merchandise database (6). It will be understood that the prebid database (7) could also contain additional information to extend the functionality of the system of the present invention, but the baseline requirements for the proper operation of the Web site system (2) would be that each record in the prebid database (7) contain bidder identification, identifying the bidder who had placed the prebid, as well as the maximum prebid amount and the auction lot from the merchandise database (6) in respect of which the prebid was placed.

The Web site system (2) also includes a plurality of HTML documents or the like (8) which are used and served to bidder Web browsers (5) during the course of the conduct and placement of a prebid in accordance with the system of the present invention.

In operation of the system (2), a bidder would access the prebid Web site system (2) using a standard Web browser (5) such as Microsoft's Internet Explorer™ or Netscape's Navigator™, which uses the HTTP protocol to communicate with the Web server (3) of the Web site (2). The Web server (3) contains a local store of documents (8) (in the form of HTML or “Web” documents) which can be requested, retrieved and reviewed by the customer/bidder via the Web browser (5). This catalogue of HTML documents (8) could include various descriptive information regarding auction lots offered for sale in an eventual live auction and would also include documents to be viewed and used in the placement of prebids with the Web site system (2). Through the browser (5), the Web site (2) and the associated server (3), a bidder would be able to transact prebidding business with the auctioneer.

The HTML document (8) served by the Web site (2) would include particular documents or pages which would be used by bidders to place prebids on auction lots stored in the merchandise database (6). By way of special hyperlinks or otherwise, the particulars of a prebid including the maximum prebid amount could be entered in the browser (5) and transmitted from the browser (5) to the server (3) for recordal in the prebid database (7).

A bidder would need to provide identifying information to the Web site system (2) along with the remainder of their prebid in order that the prebid could be properly stored in the prebid database (7) and attributed back to the appropriate bidder at the time of selection of a winning prebid at the expiry of the specified time frame, and/or at the time of the submission of a winning prebid to the live auction in respect of an auction lot. In one implementation of the prebid Web site (2), the Web site (2) might also include a bidder database which would contain details of registered bidders. The bidder database might be managed by a bidder database maintenance component of the computer program (9) in the server (3) which might also then assign some type of an identifier or symbol to each registered bidder which the bidder could use as an abbreviation or identifier in the placement of prebids with the prebid Web site system (2).

Since the identity of a bidder is required in order to validate or properly log a prebid submission in the prebid database (7), the bidder would either need to identify themselves in the prebid request which was transmitted to the Web site system (2) from their browser (5), or else the prebid Web site (2) might utilize cookie technology to allow the bidder to identify themselves from their computer at one point and the cookie would then be stored on the bidder computer (1) and could be retrieved from the bidder computer (1) by the Web server (3) at the time of receipt of a prebid submission and the software (9) within the Web server (3) would execute a query against previously stored bidder information to which the Cookie would correlate. Any of a variety of alternative techniques could be used to identify the bidder, including prompting the bidder for a user ID and/or using URL information returned by the bidder's Web browser (5).

As outlined herein, the Web site system (2) of the present invention would allow bidders to submit prebids with respect to an auction lot in the merchandise database (6) within a specified time frame. The specified time frame for all auction lots might be the same, or there might be different specified time frames within which prebids could be accepted with respect to different auction lots. It will be understood that any such variation is contemplated within the scope of the present invention.

Acceptance of prebids in respect of an auction lot would cease upon the expiry of the specified time frame with respect to that auction lot.

In addition to identifying themselves in a prebid submission, a bidder would submit a maximum prebid amount with respect to an auction lot, and the maximum prebid amount would be stored in the prebid database (7) along with the bidder identifying information and a key into the merchandise database (6) as well. For example, a bidder who wished to place a prebid of $3,000 with respect to an auction lot could submit a prebid in which the maximum prebid amount was specified to be $3,000.

When a bidder accesses the Web site (2) for the purposes of placing a prebid, the site server (3) would serve HTML documents or other content to the Web browser (5) of the bidder which would allow the bidder to enter the particulars of their prebid, including the maximum prebid amount, and might also display information pertaining to the auction lot from the merchandise database (6) and/or might also include a display of information from the prebid database (7) about previous prebids which had been accepted in respect of the merchandise or auction lot in question.

When the server (3) receives a prebid from a browser (5) of a bidder at a bidder computer (1), the software (9)/(15) within the server (3) would record the details of that prebid in the prebid database (7), provided that the specified time frame for acceptance of prebids with respect to that particular auction lot had not yet expired.

Upon expiry of the specified time frame for acceptance of prebids with respect to a particular auction lot, the server (3) and its software components (9) would select the winning prebid from prebids which had been recorded in the prebid database (7) within the specified time frame. Various types of calculations or formulae might be used to determine what was the winning prebid. In any event, once the winning prebid with respect to a particular auction lot was selected, that winning prebid could be submitted during the live auction of that auction lot, on behalf of the bidder who placed the winning prebid.

Where the live auction of one or more auction lots was going to be an actual physical auction with a bidding session taking place at an actual auction venue, the submission of the winning prebid in respect of various auction lots might consist of preparing a report for the auctioneer of the winning prebids selected with respect to each of said auction lots, and the auctioneer could then physically or verbally submit those winning prebids in respect of the auction lots in question during the bidding session on the auction lots.

Alternatively, where the live auction of one or more auction lots was to be either a hybrid physical and online auction, or where the auction was to take place entirely online through some type of a live online auction system, the prebid Web site system (2) of the present invention might be operatively connected to the auction system of the live auction and the winning prebid with respect to various auction lots could then be automatically submitted to the live auction bidding session of the online auction conducted by the auction system at the appropriate time.

Various approaches or methods, or formulae, might be used to select the winning prebid from prebids received with respect to a particular auction lot. Anticipated variations or embodiments of the winning prebid selection process are outlined in further detail below under the heading of “Selection of the Winning Prebid”.

The following sections outline in further detail some of the various embodiments or functions which might be used in conjunction with the present invention.

Merchandise Database

It will be understood that the merchandise database could contain records on auction lots for more than one live auction sale and that the parameters of prebidding which would be allowed with respect to each auction lot could be varied by storing said parameters in the merchandise database. For example, in respect of one particular auction sale, lots in that auction sale might only be available for the placement of fixed prebids, or in other cases a blend of fixed and flexible prebids might be allowed. The specified time frame within which prebids can be placed with respect to particular auction lots could vary and could actually vary between lots for the same actual live auction sale. It will be understood that this additional level of flexibility, as well as the ability to use a single prebid Web site system of the present invention to aggregate prebids on auction lots for more than one actual live auction, are all contemplated within the scope of the present invention.

The Web server (3) of the prebid Web site system (2) includes a computer program (9) which, through various software components, would carry out the administration and operation of the prebid method and system of the present invention. One aspect of the computer program (9) could be a merchandise database maintenance component (16) which would be responsible for the upkeep of records in the merchandise database (6) pertaining to auction lots on which bidders can place prebids. Each record of the merchandise database (6) could correspond to an auction lot which would be auctioned off eventually in a live auction and on which it was desired to provide bidders the ability to place prebids by way of the Web site system (2) of the present invention. The merchandise database (6) would be stored in the memory of the server (3) and the merchandise database maintenance software component (16) could be any software component capable of accessing and administering this database (6). It will be understood that the precise structure of the database (6) could be any type of database structure which could be administered by a software component (16) in the Web server (3) and that all types of data structures are contemplated within the scope of the present invention.

One function of the merchandise database maintenance software (16) could be to maintain any changes made to records of the merchandise database (6) as a result of or during the placement of prebids conducted in accordance with the system of the present invention. As well, the merchandise database maintenance software component (16) could be responsible for serving information from the merchandise database (6) either to other software components within the server (3) or Web site system (2) or to the browser (5) of a bidder through the server (3). While beyond the immediate scope of the present invention, it will also be understood that the merchandise database maintenance software (16) could also allow for administration and adding of new lots to the merchandise database (6), or the removal of lots from the merchandise database (6), or archival of information therefrom upon completion of the specified time frame for placement of prebids with respect to various auction lots.

Various types of information could be kept in the merchandise database (6) for internal use in the conduct of prebids with respect to that auction lot, or alternatively the information contained in the merchandise database (6) with respect to an auction lot might also include descriptive information, multimedia content or the like which could be displayed to a browser (5) to assist the bidder at the bidder computer (1) in the assessment or placement of a prebid in respect of an auction lot.

The internal information which might be contained within the merchandise database (6) with respect to each auction lot might include specifics of the types of prebids which are to be allowed with respect to that auction lot—for example, as will be outlined further below, it might be possible that on certain auction lots it was desired to allow the placement of fixed prebids and in other circumstances it might be allowable to place either a fixed or a flexible prebid, or a flexible prebid only, in respect of a particular auction lot. As well, the specified time frame within which prebids could be accepted by the Web site system (2) in respect of that auction lot could be stored in the merchandise database record pertaining to that auction lot and the prebid control system (15) could then identify this specified time frame with the merchandise database (6) at the time of assessing the validity of a prebid transmitted from a bidder computer (1).

Prebid Database

A prebid database (7) is also present in the computer server (3) and a prebid database maintenance component (17) would be present in the computer program (9) of the server (3) to maintain the prebid database (7).

The prebid database (7) will be used to record various prebids placed in respect of auction lots contained in the merchandise database (6). The prebids which are recorded in the prebid database (7) could then be reviewed by the prebid control system (15) upon expiry of the specified time frame for acceptance of prebids in respect of that auction lot to determine the winning prebid. The winning prebid could then be submitted by the prebid control system (15) to the actual live auction of that auction lot in due course.

It will be understood that the type of information to be stored in the prebid database (7) could again vary in levels of complexity. The base information which will need to be stored with respect to a prebid would be the maximum prebid amount, identification of the bidder having placed the prebid which might be linked to a bidder database in certain embodiments, as well as an identifier or key to the merchandise database (6) identifying the auction lot in respect of which the prebid is placed. Other data-checking fields in the data structure of the prebid database (7) might include date and time of acceptance of prebids, validation flags or the like. It will be understood that the prebid database maintenance component (17) is responsible for the maintenance of the prebid database (7) either independently or in conjunction with the prebid control system (15).

The prebid database (7) would, in one embodiment, be a database structure containing a plurality of records, each record corresponding to a prebid placed by a bidder with respect an auction lot contained in the merchandise database (6). It will be understood that the structure of the prebid database (7) could be any type of a database or file structure which is accessible to the prebid database maintenance component (17) of the server software (9). Similarly, the prebid database maintenance component (17) could be any software component which would be capable of accessing and administering the particular database structure chosen for the prebid database (7).

Prebid Control System

The handling of prebids in the Web site (2) is carried out by a prebid control system component (15) of the software (9) within the server (3) on the Web site (2). In the embodiment shown, the prebid control system (15) will interface directly or indirectly with the merchandise database (6) and the prebid database (7) for the purposes of receiving, authenticating and recording prebids received from bidder computers (1), as well as for, at the appropriate time, selecting the winning prebid in respect of an auction lot for eventual entry into the live auction of an auction lot.

As outlined in further detail herein, the basic concept of the present invention is to provide an online prebid Web site system (2) wherein prebids can be placed on auction lots by bidders, in advance of a live auction. A bidder is able to submit a prebid to the system (2) of the present invention which is recorded and then the best prebid which is received in respect of an auction lot will be entered into the live auction bidding session of that auction lot at such point in time as the live auction takes place. The system will only accept prebids in respect of an auction lot within a specified time frame and after the cut-off of said time frame the winning prebid will be selected.

The prebid control system (15) would receive the details of prebids which were transmitted to the Web site (2) from bidders from their browser (5) at their bidder computer (1). Bidders might transmit their prebid details through an HTML form or other types of HTML, XML or Java page elements or the like, any of which can be contemplated to be effective in the collection of data from a user. It will be understood that many types of data entry methods via the browser can be contemplated and insofar as any method might accomplish the objective of allowing a bidder to enter and transmit the details of a prebid to the web site system of the present invention, all such modifications and methods are contemplated within the scope of the present invention.

Upon review and validation of the data obtained in a prebid transmitted from a browser (5), the prebid control system (15) would verify that the specified time frame within which prebids were able to be accepted with respect to the particular auction lot in question was still open and that, as such, the prebid could be accepted. If the specified time frame for acceptance of prebids with respect to the auction lot in question was open and the prebid otherwise determined to be valid, the prebid control system (15) would record the details of the prebid into the prebid database (7) via the prebid management component (17).

When the specified time frame in respect of an auction lot in the merchandise database (6) expires, meaning that no further prebids can be accepted by the system (2), the prebid control system (15) then will proceed to select or determine the winning prebid from those prebids received and recorded in the prebid database (7) within the specified time frame with respect to the particular auction lot. Various formulae could be used to determine what was the winning prebid, but in any event a winning prebid would be determined and that winning prebid would then be submitted to the live auction of the auction lot by the prebid control system (15). Some foreseeable embodiments of the actual selection process for winning prebids are outlined in further detail under the next heading.

The prebid control system (15) would submit the winning prebid to the live auction of the auction lot in question. This could be done in a number of ways. Where the live auction of that auction lot was to be a physical auction by an actual auctioneer at an auction location, the prebid control system (15) could submit a winning prebid by generating a report for the auctioneer who could then manually insert that winning prebid into the auction of the auction lot at the appropriate time. Alternative to the printing of a report might be the generation of some other kind of a status report or feedback which might include an e-mail, a transmission to an Internet site of the auctioneer, or the like. It will be understood that any type of a communication of the particulars of the winning prebid from the prebid control system (15) to a live auctioneer in the case of a physical auction is contemplated within the scope of the present invention.

Alternatively, where the live auction of an auction lot on which prebids have been received was to be conducted in an online format, the prebid Web site system (2) of the present invention might be operatively connected to the online auction system of that live auction and the details of the winning prebid in respect of an auction lot could be automatically communicated to such a control system for automatic insertion or inclusion in the online live bidding session with respect to that auction lot. It might also be the case that the prebid Web site system (2) of the present invention might be modified to actually include the additional necessary software components to itself host a live online auction of these auction lots and, in that case, the software components of the online auction could access the winning prebids in the prebid database (7). It will be understood that any method of communicating the results of the prebidding process on an auction lot to the operator of a live auction is contemplated within the scope of the present invention.

As outlined above, the method of submission of such winning prebid in its maximum prebid amount to the live auction of the auction lot could take place in any number of fashions. It could also be entered into the bidding session of the live auction with respect to the auction lot at a number of different times. For example, the winning prebid with respect to an auction lot could be entered into the live auction bidding session as the opening bid on the auction lot or, as it more likely the case, the winning prebid could be entered into the live auction bidding session at some point subsequent to the commencement of bidding on the particular auction lot in question. It will be understood that these various time frames are all contemplated within the scope of the present invention as well.

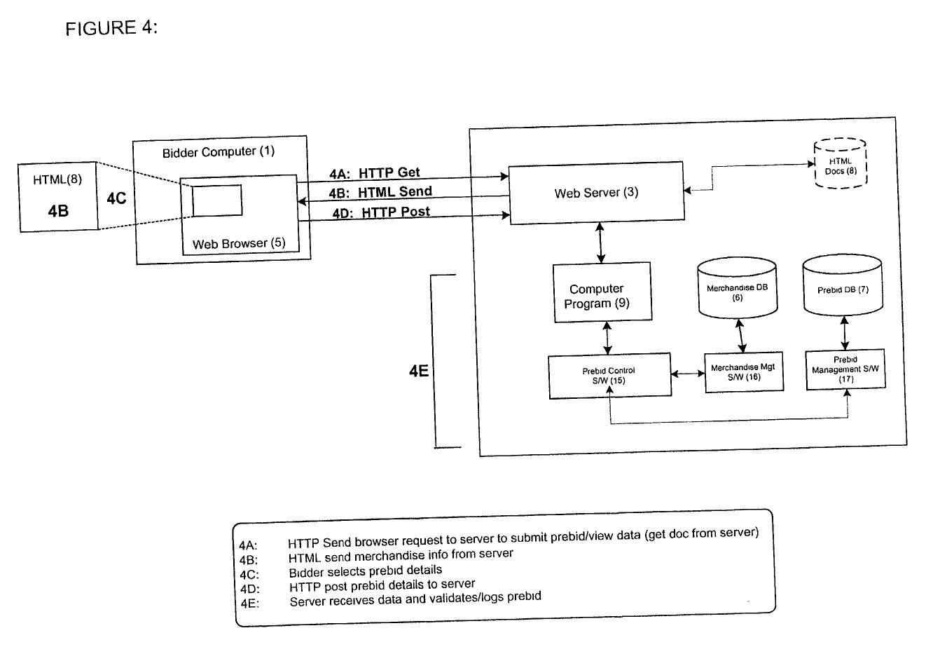

FIG. 4 demonstrates the transaction flow in the placement of a prebid in respect of an auction lot using one embodiment of the system of the present invention. The embodiment used in FIG. 4 is an embodiment of the system of the present invention which includes a merchandise database (6) and a prebid database (7), each with their own software management components (16) and (17) respectively. It will be understood that in a very basic embodiment of the invention it may not be necessary to maintain all of this information in the computer system of the Web site (2) and the obvious variations thereon will be contemplated within the scope of the present invention.

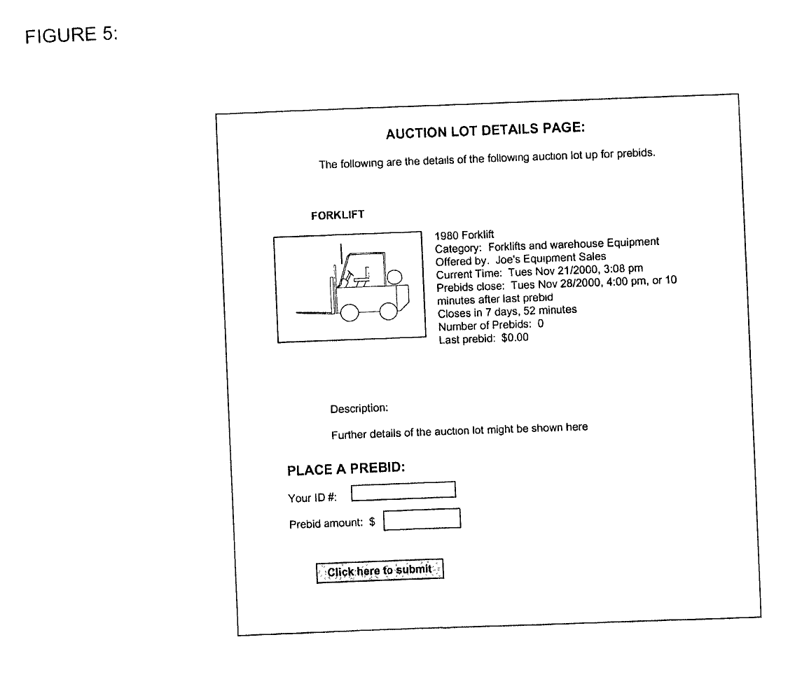

The browser request, shown at 4(a), would be transmitted from the browser (5) to the Web server (3), and upon receiving this request, the server (3) would transmit an HTML document (8) back from its document repository to the browser (5) for display to the bidder. This is shown at Step 4(b). The HTML document transmitted could show the status, etc., and also potentially spell out the time remaining to submit prebids. It might for example resemble the display of FIG. 5.

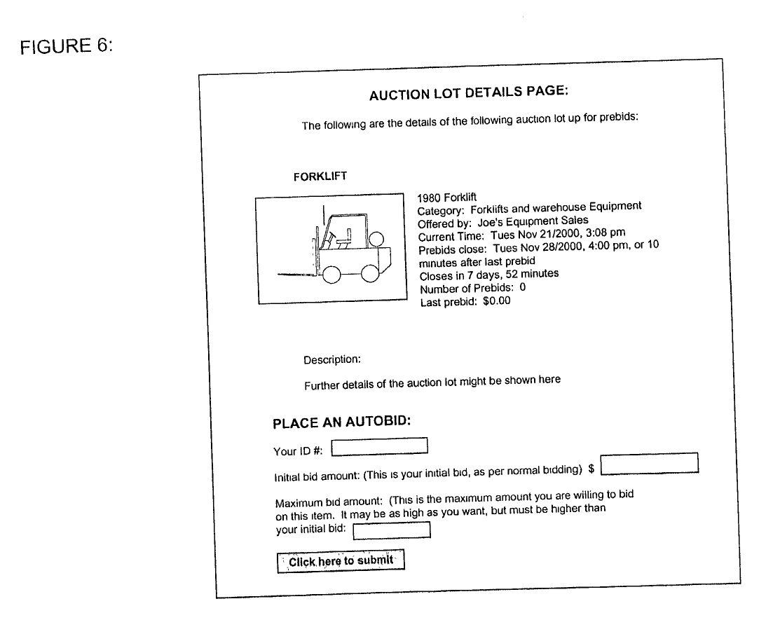

The bidder, should they wish to do so, could place a prebid by selecting the details of their prebids—i.e. fixed, flexible or otherwise, as well as the maximum, minimum or other prebid amounts or parameters. The selection of prebid criteria, by way of selecting a link or whatever other particular content design is provided for the selection of a bid increment, is shown at Step 4(c). The bid selection made at Step 4(c), along with whatever other identifying information was necessary, would be sent from the browser (5) to the server (3), shown at Step 4(d). FIG. 5 and FIG. 6 show the particulars of one method of entry of prebid particulars for either fixed or flexible prebids using an HTML form. It will be understood that this is only one example of how this aspect of the invention might be accomplished.

The next step in the process is the server (3) receiving the prebid data which had been posted from the browser (5), which is illustrated at Step 4(e). The prebid data which is received is processed by the computer program (10) and logged into, in this case, the bid database (7) upon validation.

In terms of communication between the browser (5) and the server (3), it will be understood that other alternative formats to HTML are also available, including XML, JAVA™ or the like, and that any method of serving data from the server (3) to the bidder browser (5) and displaying it therein is contemplated within the scope hereof.

As also outlined above, the bidder would need to identify themselves to the system (2) in order to place bids. The bidder might identify themselves at the time of transmitting their bid, Step 4(c)/4(d), or there might be a Cookie or some other type of Web technology installed on the bidder computer (1) which would be used to identify the bidder in accepting the bid and attributing it to the proper bidder when stored in the Web site system (2).

Upon closing of the specified time frame for acceptance of prebids with respect to an auction lot, the winning prebid could be selected.

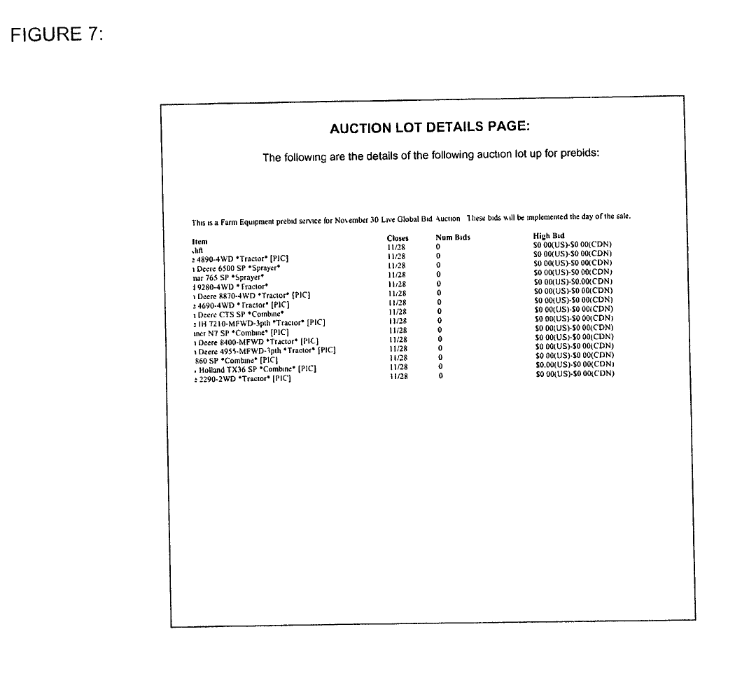

FIG. 7 shows a sample of a status screen which might be displayed to users of the web site system of the present invention showing the prebid status of various auction lots.

The system could allow bidders to browse details of merchandise or auction lots from the merchandise database, and/or details of prebids from the prebid database.

Choosing the Winning Prebid

The basic premise of the system and business method of the present invention is that bidders are allowed to place a prebid on an auction lot in advance of a live auction of this auction lot, and the bidder who places the highest or most attractive prebid will have their winning prebid entered into the bidding session of the live auction of the auction lot at such point in time as that takes place.

As outlined above, the prebid control system (15) and other software components (9) within the server (3) of the Web site system (2) of the present invention could automatically select the winning prebid from prebids recorded in the prebid database (7) within the specified time frame pertaining to a particular auction lot.

The simplest method of selecting a winning prebid from prebids received and stored in the prebid database (7), would be to select the prebid with the highest maximum prebid amount. For example, if eight prebids were received with respect to a particular auction lot and they ranged from $500 to $15,000, the highest ($15,000) prebid would be the winning prebid which would be submitted to the live auction of that auction lot when the live auction took place.

Another embodiment of the selection of the winning prebid from those received with respect to an auction lot involves some modifications to the software components in the system (2), which yield a more flexible prebidding mechanism than the mechanism of simply allowing bidders to submit one or more prebids with a maximum prebid amount to the system for recordal in the prebid database (7).

A prebid which is submitted to the Web site (2) which has only a maximum prebid amount associated therewith and no further parameters specified will be referred to herein as a “fixed prebid”. This would be the straight-forward type of a prebid referred to in the example above. The second type of a prebid which is contemplated is a “flexible” prebid, which would include not only a maximum prebid amount, but also a minimum prebid amount. This would allow a bidder to submit an opening prebid (signified by the minimum prebid amount) as well as the highest amount which they are willing to bid (their maximum prebid amount). The system could then automatically increment the flexible prebids within the range defined by their minimum and maximum prebid amounts to effectively conduct an ‘auction before the auction’ to ascertain the highest prebid which would be submitted to the live auction of the auction lot in question. Consider the following sample data, representing a prebidding contest using fixed and flexible prebids:

| | | | Minimum | Maximum |
|---|---|---|---|---|
| Prebid # | Bidder | Prebid Type | Prebid Amount | Prebid Amount |
| 1 | Tim | Fixed | | $350 |
| 2 | John | Fixed | | $500 |
| 3 | Frank | Flexible | $600 | $5,000 |
| 4 | Tim | Fixed | | $1,000 |
| 5 | Dan | Flexible | $1,200 | $4,000 |
| 6 | Tim | Fixed | | $3,000 |

Flexible prebids could introduce an additional level of competition amongst bidders in their prebids. The minimum prebid amount would be the first amount which is used to calculate or compare prebids and based on the bid increment as well as the spread between the minimum and maximum prebid amounts, a particular prebid could allow the system (2) a certain degree of leeway in “bidding up” their prebid to be successful over other fixed or flexible prebids with low minimum or maximum prebid amounts.

In this particular example 6 prebids are shown. Tim obviously has considerable interest in the item since he has placed 3 fixed prebids. The flexible prebids of the others, however, allow them to ‘set it and forget it’, so to speak, within their comfortable bidding range. For example, Frank's $600 opening bid is too low, but he has set a maximum prebid amount of $5,000, which is the highest of the batch, so he would be the successful prebidder.

Upon determination of the winning prebid as outlined above, the maximum prebid of the winning prebid would be the amount which is submitted to the live auction of the auction lot. By and large, it is anticipated that it will be preferable method approach, since it does provide the maximum possible return to the auctioneer and the vendor of the auction lot, without exceeding the highest bid expectations of the successful prebidder. This is the trade-off which a bidder might be subject to in exchange for the convenience of the flexible prebid. It is, however, alternatively contemplated that in certain cases it might be desired to set the maximum bid amount for the winning prebid to the final prebid balance of that prebid from the last knockout calculation, which potentially is the maximum amount for the winning prebid even though the initially specified maximum bid amount is either at or above the minimum bid amount of the flexible prebid.

This type of a calculation system would accommodate various prebid filing patterns wherein every prebid is a flexible prebid, every prebid is a fixed prebid, or alternatively where there is a combination of fixed and flexible prebids filed with respect to an auction lot. A functional extension of the merchandise database (6) might be to specify within the merchandise database (6), with respect to a particular auction lot, the types of prebids which can be made and then the prebid control system (12) would only allow, for example, fixed prebids to be filed in respect of an auction lot for which only fixed prebids are desired, and so on.

It will be understood that additional method of selection of a winning prebid from prebids received in the prebid database during the specified time frame with respect to an auction lot can also be contemplated and are also understood to be within the scope of the claimed invention.

Conclusion

While the invention has been described herein with reference to certain preferred embodiments, these embodiments have been presented by way of example only, and not to limit the scope of the invention. Accordingly, the scope of the invention should be defined only in accordance with the claims that follow. In the following claims, reference characters used to designate claim steps are provided for convenience of description only, and are not intended to imply any particular order for performing the steps.

We claim:

1. A method of accepting prebids in advance of a live auction, said method comprising:
a) providing a prebid web site system to accept prebids, said web site system including a merchandise database of information pertaining to auction lots to be sold in live auctions and a prebid database in which the details of prebids received in respect of said auction lots can be stored;
b) using said web site system to accept prebids in respect of an auction lot by:
i) allowing bidders to transmit prebids from bidder computers to said web site system within a specified time frame, wherein each prebid transmitted includes a maximum prebid amount;
ii) recording said prebids in said prebid database;
iii) upon expiry of said specified time frame accepting no further prebids and selecting the winning prebid; and
iv) submitting said winning prebid from the prebid database to the live auction of said auction lot.

2. The method of claim 1 wherein the winning prebid in respect of an auction lot is the prebid with the highest maximum prebid amount.

3. The method of claim 1 wherein said live auction is a physical auction.

4. The method of claim 1 wherein said live auction is an online auction.

5. The method of claim 1 wherein said live auction is a combined physical and online auction.

6. The method of claim 1 wherein a bidder is only allowed to submit one prebid in respect of each auction lot.

7. The method of claim 1 wherein a bidder is able to submit more than one prebid in respect of each auction lot.

8. The method of claim 4 wherein said prebid web site system is operatively connected to said online auction, and wherein said winning prebid is automatically submitted to the live auction.

9. The method of claim 3 wherein the submission of said winning prebid comprises manually entering said winning prebid into said physical auction sale.

10. The method of claim 5 wherein said prebid web site system is operatively connected to said online auction, and wherein said winning prebid is automatically submitted to said live auction.

11. The method of claim 1 wherein a prebid can optionally include an opening prebid amount in addition to the maximum prebid amount.

12. The method of claim 1 wherein no two prebids are allowed to have the same maximum prebid amount.

13. A web site system for accepting prebids from bidders in advance of live auctions, said web site system comprising:
a) a merchandise database containing information pertaining to auction lots to be sold in said live auctions;
b) a prebid database containing of prebid placed in respect of auction lots;
c) a prebid control system which will allow placement of prebids in respect of an auction lot in the following steps:
i) within a specified time frame, receiving the details of a prebid including a maximum prebid amount from a bidder computer;
ii) recording said prebids in said prebid database; and
iii) upon expiry of said specified time frame accepting no further prebids from bidders, and selecting a winning prebid from those prebids recorded in said prebid database; and
iv) submitting said winning prebid to the live auction of said auction lot.

14. The web site system of claim 13 wherein the winning prebid in respect of an auction lot is the prebid with the highest maximum prebid amount.

15. The web site system of claim 13 wherein said live auction is a physical auction.

16. The web site system of claim 13 wherein said live auction is an online auction.

17. The web site system of claim 13 wherein said live auction is a combined physical and online auction.

18. The web site system of claim 15 wherein said web site system is operatively connected to said online auction, and wherein the winning prebid will be automatically submitted to said online auction by the prebid control system.

19. The web site system of claim 16 wherein said winning prebid is manually entered into said live auction.

20. The web site system of claim 13 wherein a bidder is only able to submit one prebid in respect of an auction lot.

21. The web site system of claim 13 wherein a bidder is able to submit more than one prebid in respect of an auction lot.

22. The web site system of claim 13 wherein the prebid control system allows a bidder to view information from the merchandise database from their bidder computer.

23. The web site system of claim 13 wherein the prebid control system allows a bidder to view information from the prebid database from their bidder computer.

24. The web site system of claim 13 wherein a prebid submitted by a bidder can optionally include an opening prebid amount in addition to the maximum prebid amount, being a flexible prebid.

25. The web site system of claim 24 wherein the prebid control system controls the type of bids, either flexible prebids or fixed prebids or both, which will be accepted in respect of an auction lot.

26. The method of claim 1 further comprising displaying information about prebids already placed in said web site system to bidders in advance of their transmitting a prebid.
